(19) United States
(12) Patent Application Publication
(10) Pub. No.: US 2026/0138928 A1
(43) Pub. Date: May 21, 2026

(54) Additive Manufacturing of Structural Components on the Basis of Silicone Carbide with Embedded Diamond Particles

(71) Applicant: KYOCERA Fineceramics Europe GmbH, Mannheim (DE)

(72) Inventors: Nikolaos Katsikis, Waldsassen (DE); Sarah Diener, Selb (DE); Carsten Russner, Lauf a.d Pegnitz (DE)

(21) Appl. No.: 19/438,272

(22) Filed: Dec. 31, 2025

Related U.S. Application Data
(62) Division of application No. 17/263,182.

(30) Foreign Application Priority Data
Aug. 20, 2018 (EP) 18189786.9

(51) Int. Cl. C04B 35/565; B28B 1/00; B32B 18/00; B33Y 10/00; B33Y 70/10; C04B 35/626; C04B 35/63

(52) U.S. Cl. CPC C04B 35/565; B28B 1/001; B32B 18/00; B33Y 10/00; B33Y 70/10; C04B 35/62655; C04B 35/63; C04B 2235/3826; C04B 2235/427; C04B 2235/5436; C04B 2235/5445; C04B 2235/5454; C04B 2235/6026; C04B 2235/6027; C04B 2235/606

(57) ABSTRACT

The invention relates to a method for producing structural components that have diamond particles embedded in a silicon carbide matrix, and to the structural components that can be obtained by this method.

### CROSS REFERENCE TO RELATED APPLICATIONS

This application is divisional application of U.S. patent application Ser. No. 17/263,182, filed on Jan. 26, 2021, which is the U.S. National Stage entry of International Patent Application No. PCT/EP2019/071817 having a filing date of Aug. 14, 2019, which claims priority to and the benefit of European Patent Application No. 18189786.9 filed in the European Patent Office on Aug. 20, 2018, the entire contents of which are incorporated herein by reference.

### BACKGROUND

The present invention relates to a process for producing components having diamond particles embedded in a silicon carbide matrix, and to components obtainable by this process.

In recent years, a trend towards more and more precision, miniaturization and ecological optimization has been recognizable in many fields, from mechanical engineering to semiconductor production, and aerospace technology, in both products and technology, such as milling, grinding, honing, drilling, or additive manufacturing. Thus, in order to cope with the continuously increasing performance requirements for electronic or mechanical components, there is a need for manufacturing methods that allow for a high positional accuracy and dimensional accuracy.

The material silicon carbide (SiC) has become established as a popular material for components, in particular, in the field of the semiconductor industry, because of its high hardness and rigidity combined with a low density and low thermal expansion. Diamond particles can be admixed with the silicon carbide to increase the wear resistance and temperature performance of such products made of silicon carbide. This has advantages in terms of wear resistance, which are also in demand in other applications, such as for tools, such as milling, honing, drilling or grinding tools, or for wear protection components, such as slide rings, nozzles, coatings, or pins. In addition, when cooling channels are simultaneously implemented, the temperature performance and thus heat dissipation and the tool lives or the processing parameters can be optimized. A shape optimized in terms of weight or application, such as in bionics, is also possible.

In contrast to conventional materials, such as silicon-infiltrated silicon carbide (SiSiC), sintered silicon carbide (SSiC) or glass ceramics, diamond-filled silicon carbide (DiaSiC) improves the required material properties in both tools prepared therefrom for processing components, and in the components made of DiaSiC. However, the conventional processing methods for DiaSiC, such as slip casting or pressing, limit the integration of complex shapes that are required for demanding applications. This is due, in particular, to the limited processing possibilities for diamond-filled silicon carbide, because the non-ceramized component exhibits a high tool wear when processed, the milling dust obtained is difficult to reuse in view of the diamonds, and the possibility of hard processing is rather limited, especially for silicon-infiltrated DiaSiC because of the hard-soft transitions between the diamond and metallic silicon. Thus, there is a need for a process for processing diamond-filled silicon carbide that overcomes the above-mentioned drawbacks.

WO 99/12866 describes a method for manufacturing a diamond-silicon carbide-silicon composite from diamond particles, comprising the steps of forming a work piece having a porosity of from 25 to 60% by volume, heating the work piece and controlling the heating temperature and heating time so that a certain desired amount of graphite is created by graphitization of diamond particles, thereby creating an intermediate body, in which the amount of graphite created by graphitization is from 1 to 50% by weight of the diamond quantity, and infiltrating silicon into the intermediate body.

U.S. Pat. No. 8,474,362 describes a diamond-reinforced ceramic composite material based on silicon carbide. The addition of diamond enhances the hardness and Young's modulus of the material, whereby it is specifically suitable for use as an armor material. The composite material is prepared by sedimentation casting.

WO 2004/108630 describes a method for preparing a fully dense diamond-silicon carbide composite, comprising ball-milling a mixture of microcrystalline diamond powder and crystalline silicon powder, and the mixture obtained is then sintered at a pressure of 5 GPa to 8 GPa and a temperature of 1400 K to 2300 K.

WO 2015/112574 describes a multilayer substrate that includes a composite layer including particles of diamond and silicon carbide and a diamond layer grown by chemical vapor deposition (CVD) on the composite layer.

EP 2 915 663 describes a method including depositing alternating layers of a ceramic powder and a pre-ceramic polymer, in which the layer of the pre-ceramic polymer is deposited in a shape corresponding to a cross-section of an object. The pre-ceramic polymer is preferably a poly(hydridocarbyne). In this way, a polycrystalline diamond made from detonation nanodiamond and poly(hydridocarbyne) is obtainable.

U.S. Pat. No. 9,402,322 describes a method for forming an optical waveguide using a 3D printer, in which a plurality of layers of poly(hydridocarbyne) are deposited in the geometry of a cladding for an optical waveguide; and a plurality of layers of poly(methylsilyne) are deposited in the shape of a core of the optical waveguide; and then heating the layers, an optical waveguide being formed of a core of polycrystalline silicon carbide surrounded by polycrystalline diamond.

US 2018/0087134 relates to a method of forming a polycrystalline diamond compact (PDC), comprising: forming a gradient interfacial layer having a gradient of coefficients of thermal expansion by forming a plurality of sublayers, at least two of which have different coefficients of thermal expansion, and attaching it between a thermally stable diamond table (TSP), and a base. The gradient of the gradient interfacial layer is somewhere between the coefficient of thermal expansion of the base, and that of the thermally stable diamond table.

However, the methods described in the prior art have the disadvantage that complex components can be prepared only with a very high expenditure, if at all. Therefore, it is the object of the present invention to provide a process that allows for the production of components based on silicon carbide reinforced with diamond particles at a high structural resolution.

### DETAILED DESCRIPTION

Surprisingly, it has been found that components with a correspondingly high structural resolution can also be prepared from silicon carbide reinforced with diamond particles by using additive manufacturing methods.

Therefore, the present invention firstly relates to a process for preparing a component by using additive manufacturing methods, in which the component has diamond particles embedded in a silicon carbide matrix, wherein said process comprises a step in which a first layer of at least one first material based on silicon carbide is deposited, and another step in which a second layer of at least one second material based on silicon carbide is deposited, wherein at least one of said materials based on silicon carbide includes diamond particles.

Surprisingly, it has been found that complex and delicate structures may also be realized at a high resolution in this way, which are not accessible by the use of conventional manufacturing methods, such as pressing. In this way, for example, it is possible in a simple and uncomplicated manner to provide components having a complex inner structure, which results, for example, from the presence of interior cooling channels.

Further surprisingly, it has been found that an improved mold stability can be achieved also for larger-sized components when a material based on silicon carbide is employed as compared to, for example, materials with no silicon carbide primary particles, which is advantageous, in particular, in the further processing of the component. Further, in this way, a stable body made of a material that is not attacked by silicon in subsequent process steps, for example, infiltrating with silicon, is provided.

The best structural resolution and the highest dimensional accuracy were achieved when the production of the component took place in individual layers. Therefore, an embodiment of the process according to the invention in which the construction of the component is performed layer by layer is preferred. In a preferred embodiment, the construction of the component is performed from at least 50 layers, preferably at least 70 layers.

In a preferred embodiment, the additive manufacturing method is selected from the group consisting of stereolithography (SL), material jetting/direct ink printing (DIP), direct ink writing (DIW), robocasting (FDM), binder jetting (3DP), selective laser sintering, and combinations of such methods.

A common feature of these methods is the layer-by-layer construction of the component during the manufacturing process. Therefore, the process according to the invention comprises a step in which a first layer of an at least first material based on silicon carbide is deposited, and another step in which a second layer of an at least second material based on silicon carbide is deposited, wherein at least one of the materials includes diamond particles. Preferably, the diamond particles are selected from the group consisting of nanodiamond particles, microdiamond particles, and mixtures thereof.

Within the scope of the present invention, “nanodiamond particles” refers to diamond particles having a particle size of not more than 200 nm. Within the scope of the present invention, “microdiamond particles” refers to diamond particles having a particle size of at least 2 μm. Said particle size can be determined, for example, by laser diffractometry.

In a preferred embodiment, the nanodiamond particles used in the process according to the invention have a particle size of from 40 to 160 nm, preferably from 50 to 150 nm, respectively determined by laser diffractometry. In a further preferred embodiment of the present invention, the microdiamond particles used in the process according to the invention have a particle size of from 3 to 300 μm, preferably from 4 to 100 μm, more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a preferred embodiment, the first material based on silicon carbide has microdiamond particles embedded therein, wherein said microdiamond particles preferably have a particle size of from 3 to 300 μm, more preferably from 4 to 100 μm, even more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a further preferred embodiment, the second material based on silicon carbide has nanodiamond particles embedded therein, wherein said nanodiamond particles preferably have a particle size of from 40 to 160 nm, more preferably from 50 to 150 nm. In a further preferred embodiment, the first material based on silicon carbide has nanodiamond particles embedded therein, wherein said nanodiamond particles preferably have a particle size of from 40 to 160 nm, more preferably from 50 to 150 nm. In a further preferred embodiment, the second material based on silicon carbide has microdiamond particles embedded therein, wherein said microdiamond particles preferably have a particle size of from 3 to 300 μm, more preferably from 4 to 100 μm. In each case, the particle size can be determined by laser diffractometry. More preferably, the microdiamond particles have a particle size of from 3 to 300 μm, preferably from 4 to 100 μm, more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a preferred embodiment, the diamond particles are a mixture of diamond particles, wherein said mixture preferably includes nanodiamond particles and microdiamond particles, wherein said nanodiamond particles preferably have a particle size of from 40 to 160 nm, especially from 50 to 150 nm, and said microdiamond particles preferably have a particle size of from 3 to 300 μm, preferably from 4 to 100 μm, more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a further preferred embodiment, the process according to the invention further comprises a step in which a layer of a material based on silicon carbide that contains no diamond particles is deposited. This step can be performed anytime during the process according to the invention, preferably before the first layer is deposited, or between the deposition of the first layer and of the second layer, or after the first layer and/or the second layer have been deposited.

In a further preferred embodiment, the diamond particles employed have a coating.

Surprisingly, it has been found that the process according to the invention allows for the production of components whose composition, for example, with respect to the amount, particle shape or particle size of the diamond particles, varies over the volume of the component. Such variation can be achieved, in particular, by the use of different materials based on silicon carbide. Preferably, the first material based on silicon carbide and the second material based on silicon carbide are the same or different.

In a preferred embodiment, said at least first and/or said at least second material are deposited in the form of a powder. In addition to said material based on silicon carbide, the powder preferably comprises further components selected from the list consisting of diamond particles, graphite, carbon black, and organic compounds.

In an alternatively preferred embodiment, said at least first and/or said at least second material are deposited in the form of a slip. In addition to said material based on silicon carbide, the slip comprises further components selected from the list consisting of diamond particles, graphite, carbon black, and organic compounds. Preferably, said slip further comprises a liquid component. Preferably, said liquid component is a component selected from the group consisting of water, organic solvents, and mixtures thereof.

In a preferred embodiment, the process according to the invention further comprises the deposition of a binder, wherein said binder is preferably deposited in accordance with the cross-section of the component to be produced. The binder preferably comprises one or more organic compounds selected from the group consisting of resins, polysaccharides, poly(vinyl alcohol), cellulose, and cellulose derivatives, lignin sulfonates, polyethylene glycol, polyvinyl derivatives, polyacrylates, and mixtures thereof.

The additive manufacturing method for producing a component having diamond particles embedded in a silicon carbide matrix is preferably derived from the method of direct ink writing.

Therefore, in a preferred embodiment, the process according to the invention comprises the following steps:
a) depositing at least one first material based on silicon carbide, wherein said material is deposited in the form of a bead corresponding to the desired geometry of the later component to obtain a first layer;
b) depositing at least one second material based on silicon carbide on at least one portion of the first layer, wherein said material is deposited in the form of a bead corresponding to the desired geometry of the later component to obtain a second layer;
c) repeating steps a) and b) until the desired component has been obtained;
wherein at least one of the two materials based on silicon carbide includes diamond particles, preferably those selected from the group consisting of nanodiamond particles, microdiamond particles, and mixtures thereof. Said nanodiamond particles preferably have a particle size of from 40 to 160 nm, especially from 50 to 150 nm, and said microdiamond particles preferably have a particle size of from 3 to 300 μm, more preferably from 4 to 100 μm, even more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a preferred embodiment of this alternative, the process according to the invention further comprises one or more drying steps. Said drying is preferably performed respectively after the deposition of the first and/or second material. Further preferably, said first material and/or said second material are the same or different.

In a further preferred alternative embodiment, the process according to the invention comprises the following steps:
a) depositing a first slip comprising silicon carbide to obtain a first layer;
b) curing at least part of the first layer in accordance with the desired geometry of the later component;
c) depositing a second slip comprising silicon carbide to obtain a second layer;
d) curing at least part of the second layer in accordance with the desired geometry of the later component;
e) repeating steps a) to d) until the desired component has been obtained;
wherein at least one of said slips further includes diamond particles, preferably those selected from the group consisting of nanodiamond particles, microdiamond particles, and mixtures thereof. Said nanodiamond particles preferably have a particle size of from 40 to 160 nm, especially from 50 to 150 nm, and said microdiamond particles preferably have a particle size of from 3 to 300 μm, more preferably from 4 to 100 μm, even more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a preferred embodiment, said first and/or second slip further comprises photoactive polymers. These polymers are preferably selected from the group consisting of resin-based acrylates or water-based acrylamides, dyes for energy conversion, polysaccharides, glycosaminoglycan derivatives based on dextran, hyaluronan, or chondroitin sulfates. Further, said first and/or second slip preferably comprises a further carbon source, preferably graphite or carbon black, other organic components, and a liquid phase. For example, said liquid phase may be water, organic solvents, or mixtures thereof. In a preferred embodiment, the first and second slips are the same or different.

The curing in steps b) and d) of the described alternative of the process according to the invention is preferably performed by a laser.

In an further preferred alternative, the process according to the invention comprises the following steps:
a) depositing a first material based on silicon carbide;
b) depositing a binder in accordance with the desired geometry of the later component;
c) optionally drying the binder;
d) depositing a second material based on silicon carbide;
e) depositing a binder in accordance with the desired geometry of the later component;
f) optionally drying the binder; and
g) repeating steps a) to f) until the desired component has been obtained;
wherein at least one of the two materials based on silicon carbide includes diamond particles, preferably those selected from the group consisting of nanodiamond particles, microdiamond particles, and mixtures thereof. Said nanodiamond particles preferably have a particle size of from 40 to 160 nm, especially from 50 to 150 nm, and said microdiamond particles preferably have a particle size of from 3 to 300 μm, more preferably from 4 to 100 μm, even more preferably from 30 to 300 μm, especially from 40 to 100 μm, respectively determined by laser diffractometry.

In an alternatively preferred embodiment, the microdiamond particles have a particle size of from 3 to 10 μm and/or from 25 to 45 μm, respectively determined by laser diffractometry.

In a preferred embodiment of this alternative, said first material and/or said second material are the same or different.

The first and second materials can be deposited in different forms. In a preferred embodiment, the depositing is effected in the form of a powder or slip. In the case where the first and second materials are deposited in the form of a slip, the process according to the invention preferably further comprises a step in which the layers deposited by means of a slip are dried.

In a preferred embodiment, the process according to the invention further comprises a demolding step to obtain the desired component. In this step, superfluous material built up during the production process is removed. In this demolding step, conventional processes usually bear the risk that the component may be damaged because of a lack of mold stability. Within the scope of the present invention, it has been surprisingly found for one type of process that the demolding can be easily effected by washing without the component being adversely affected. Therefore, an embodiment is preferred in which the demolding step includes washing the component with a liquid medium, said liquid medium preferably being water, organic solvents, or mixtures thereof.

In a further preferred embodiment of the process according to the invention, the component is further subjected to a debindering step. The removal of the binder is preferably effected thermally by heating the component.

In a further preferred embodiment, the process according to the invention further comprises the sintering of the component obtained. The sintering can provide the component with further strength. The sintering is preferably effected without additional pressure, i.e., at a pressure that corresponds to the ambient pressure (normal pressure) or below. “Normal pressure” means a pressure that corresponds to the average value of the atmospheric pressure on the earth's surface, being from 100 kPa to 102 kPa (1 to 1.02 bar). The “pressureless” sintering has the advantage that even delicate structures or interior structures that were formed during the manufacturing process are also maintained during and after the sintering.

Within the scope of the process according to the invention, the ceramizing of the component is preferably effected by an infiltration step. It has been found that the properties of the component obtained by the process according to the invention can be improved by infiltrating the component with silicon. Therefore, an embodiment is preferred in which the process according to the invention further comprises a step in which the component obtained is further subjected to an infiltration step with silicon. For this, methods known to those skilled in the art can be employed, such as immersion into liquid molten silicon, common melting of the component and the silicon, in which the silicon is supplied as a packing, cake or slip directly or indirectly through wicks or intermediate plates.

The present invention further relates to a component having diamond particles embedded in a silicon carbide matrix, preferably those selected from the group consisting of nanodiamond particles, microdiamond particles, and mixtures thereof. Said nanodiamond particles preferably have a particle size of from 40 to 160 nm, especially from 50 to 150 nm, and said microdiamond particles preferably have a particle size of from 3 to 300 μm, preferably from 4 to 100 μm, more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

Preferably, the component according to the invention is obtainable by the process according to the invention. Surprisingly, it has been found that such components have a high structural resolution and a high dimensional accuracy. Therefore, an embodiment is preferred in which the component is a component having a complex geometry. Preferably, the component according to the invention has at least one macroscopically structured surface, wherein said structured surface has protrusions and/or shoulders, for example, and/or interior structures, such as channels.

Further surprisingly, it has been found that the proportion of diamond particles in the component could be increased significant over conventional production processes. Therefore, an embodiment is preferred in which the component has a concentration of diamond particles of from 30 to 80% by volume, preferably from 40 to 70% by volume, respectively based on the total volume of the component.

The process according to the invention allows for the production of components whose properties can be adapted individually to the respective requirements, for example, by using different materials based on silicon carbide. In this way, for example, the concentration, the size and shape of the diamond particles in the component can be varied over its total volume. Thus, components having a corresponding gradient can be obtained.

Therefore, an embodiment is preferred in which the concentration of the diamond particles varies over the total volume of the component. Thus, for example, a component can be provided that has a higher concentration of diamond particles in layers close to the surface as compared to more interior layers.

In a preferred embodiment, the component according to the invention comprises a mixture of diamond particles including nanodiamond particles and microdiamond particles. Said nanodiamond particles preferably have a particle size of from 40 to 160 nm, especially from 50 to 150 nm. Said microdiamond particles preferably have a particle size of from 3 to 300 μm, preferably from 4 to 100 μm. The particle size can be determined, for example, by laser diffractometry. The microdiamond particles contained in the component preferably have a particle size of from 3 to 300 μm, preferably from 4 to 100 μm, more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

It has been found advantageous if the component has a gradient with respect to the particle size of the diamond particles. In this way, the properties of nanodiamond particles and microdiamond particles can be combined in an advantageous way. Nanodiamond particles have great advantages with respect to the shaping or homogeneity of the structure, which are highly desirable especially in the peripheral zone of a component or tool. In contrast, microdiamonds can be embedded more simply into a ceramic matrix from an economic and technical point of view, and at the same time satisfy desirable properties, such as a high thermal conductivity, high modulus of elasticity, or high fracture toughness. Therefore, an embodiment of the component according to the invention is preferred in which the particle size of the diamond particles varies over the total volume of the component. In particular, an embodiment is preferred in which the diamond particles are distributed successively with increasing size from the surface of the component to its center. An embodiment is particularly preferred in which the component according to the invention includes several layers, especially a base layer that is free from diamond particles, an intermediate layer that comprises microdiamond particles, and a top layer that comprises nanodiamond particles.

In a preferred embodiment, the shape of the diamond particles varies over the total volume of the component.

In a further preferred embodiment, the composition of the component varies over its total volume. This can be achieved, for example, by adding different additives besides the materials based on silicon carbide used for the preparation of the component.

The present invention further relates to the use of diamond particles embedded in a silicon carbide matrix in additive manufacturing methods. Preferably, the diamond particles are those selected from the group consisting of nanodiamond particles, microdiamond particles, and mixtures thereof. Said nanodiamond particles preferably have a particle size of from 40 to 160 nm, especially from 50 to 150 nm, and said microdiamond particles preferably have a particle size of from 3 to 300 μm, more preferably from 4 to 100 μm, even more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

In a particularly preferred embodiment, the diamond particles are a mixture of nanodiamond particles and microdiamond particles, wherein said nanodiamond particles preferably have a particle size of from 40 to 160 nm, especially from 50 to 150 nm, and said microdiamond particles preferably have a particle size of from 3 to 300 μm, preferably from 4 to 100 μm, more preferably from 30 to 300 μm, especially from 40 to 100 μm, respectively determined by laser diffractometry. In an alternatively preferred embodiment, the microdiamond particles have a particle size of from 3 to 10 μm and/or from 25 to 45 μm, respectively determined by laser diffractometry.

### BRIEF DESCRIPTION OF THE DRAWINGS

FIG. 1 shows an exemplary structure of a component according to the invention made of silicon carbide and having a gradient of particle size of the diamond particles embedded in the silicon carbide matrix.

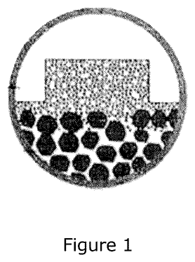

What is claimed:

1. A process for preparing a component by using additive manufacturing methods, characterized in that the component has diamond particles embedded in a silicon carbide matrix, wherein said process comprises a step in which a first layer of at least one first material based on silicon carbide is deposited, and another step in which a second layer of at least one second material based on silicon carbide is deposited, wherein at least one of said materials based on silicon carbide includes diamond particles.

2. The process according to claim 1, characterized in that the additive manufacturing method is selected from the group consisting of stereolithography (SL), material jetting/direct ink printing (DIP), direct ink writing (DIW), robocasting (FDM), binder jetting (3DP), selective laser sintering, and combinations of such methods.

3. The process according to claim 1, characterized in that the first material based on silicon carbide and the second material based on silicon carbide are the same or different.

4. The process according to claim 1, characterized in that the diamond particles are diamond particles selected from the group consisting of nanodiamond particles, microdiamond particles, and mixtures thereof, wherein said nanodiamond particles have a particle size of from 40 to 160 nm and said microdiamond particles preferably have a particle size of from 3 to 300 μm, respectively, as determined by laser diffractometry.

5. The process according to claim 1, characterized in that the process comprises the following steps:
a) depositing a first material based on silicon carbide;
b) depositing a binder in accordance with the desired geometry of the later component;
c) optionally drying the binder;
d) depositing a second material based on silicon carbide;
e) depositing a binder in accordance with the desired geometry of the later component;
f) optionally drying the binder; and
g) repeating steps a) to f) until the desired component has been obtained;
wherein at least one of the two materials based on silicon carbide includes diamond particles.

6. The process according to claim 5, characterized in that said at least first and/or said at least second material are deposited in the form of a powder.

7. The process according to claim 5, characterized in that said at least first and/or said at least second material are deposited in the form of a slip.
